(19) United States
(12) Patent Application Publication
(10) Pub. No.: US 2026/0103000 A1
(43) Pub. Date: Apr. 16, 2026

(54) SYSTEMS AND METHODS FOR OPTIMIZED INK SPREAD ACROSS MEDIA RANGE IN AQUEOUS INKJET PRINTING

(71) Applicant: Xerox Corporation, Norwalk, CT (US)

(72) Inventors: Jason M. LeFevre, Penfield, NY (US); Douglas K. Herrmann, Webster, NY (US); Seemit Praharaj, Marlborough, NH (US); Varun Sambhy, Pittsford, NY (US); Anthony Condello, Webster, NY (US); Jorge Alvarez, Webster, NY (US); Christine A. Steurrys, Williamson, NY (US); Mark Petropoulos, Webster, NY (US); Peter Gulvin, Webster, NY (US)

(21) Appl. No.: 18/916,872

(22) Filed: Oct. 16, 2024

(51) Int. Cl. B41J 2/125; B41J 2/11; B41J 29/393

(52) U.S. Cl. CPC B41J 2/125; B41J 2/11; B41J 29/393

(57) ABSTRACT

Systems comprising: printheads configured to apply ink marks to a sheet of media; sensor(s) configured to scan the sheet of media to obtain scan data; and processor(s) configured to analyze the scan data to (i) determine whether an amount of ink spread on at least one side of the sheet of media is within a range of values, and or (ii) determine whether a difference between a first average line width associated with a first side of the sheet of media and a second average line width associated with a second side of the sheet of media is greater than a threshold value. The system is configured to perform a print job based on results of the analyzing.

### BACKGROUND

### Description of the Related Art

A production inkjet printing machine can print on Inkjet treated medias or non-Inkjet treated medias. Within those two media treatment types, it can also print on medias having different coating types. These coatings include a glossy coating, or a matte or silk coating, or there can be no coating at all. The amount to which the ink “spreads” when it encounters a given media is important to the overall image quality performance on a given stock. If the ink spread is too little, then the visibility of missing jets, bad jet directionality (drop position placement), and the appearance of fine streaks in the process direction will become objectionable. On the other hand, if the ink spread is too much, then fine features (such as small texts, fine lines, negative lines, etc.) will have poor edge definition, appear ragged and non-uniform.

### SUMMARY

The present disclosure concerns a system, comprising: printheads configured to apply ink marks to a sheet of media; sensor(s) configured to scan the sheet of media to obtain scan data; and processor(s) configured to analyze the scan data to (i) determine whether an amount of ink spread on at least one side of the sheet of media is within a range of values, and or (ii) determine whether a difference between a first average line width associated with a first side of the sheet of media and a second average line width associated with a second side of the sheet of media is greater than a threshold value. The system is configured to perform a print job in a manner selected based on results of the analyzing.

The present disclosure also concerns a system, comprising: a processor; and a non-transitory computer-readable medium comprising one or more programming instructions that when executed by the processor, cause the processor to: control printheads to apply ink marks to a sheet of media; control a sensor to generate scan data by scanning the sheet of media; analyze the scan data to (i) determine whether an amount of ink spread on at least one side of the sheet of media is within a range of values, and or (ii) determine whether a difference between a first average line width associated with a first side of the sheet of media and a second average line width associated with a second side of the sheet of media is greater than a threshold value; and control a printer to perform a print job in a manner selected based on results from analyzing the scan data.

The present disclosure further concerns implementing systems and methods for operating a printing system. The methods comprise: applying, by printheads of the printing system, ink marks to a sheet of media; scanning, by a sensor of the printing system, the sheet of media to obtain scan data; analyzing, by a processor of the printing system, the scan data to (i) determine whether an amount of ink spread on at least one side of the sheet of media is within a range of values, and or (ii) determine whether a difference between a first average line width associated with a first side of the sheet of media and a second average line width associated with a second side of the sheet of media is greater than a threshold value; and performing a print job by the printing system in a manner selected based on results of the analyzing.

### BRIEF DESCRIPTION OF THE DRAWINGS

The present solution will be described with reference to the following drawing figures, in which like numerals represent like items throughout the figures.

FIGS. 1A-1B (collectively referred to as “FIG. 1”) provides an illustration showing ink spread performance for approximately 10 per each glossy and matte offset coated media.

FIG. 2 provides an illustration showing a difference in ink spread on first and second sides of a Blazer gloss 80 # cover stock.

FIG. 3 provides a photomicrograph showing first and second side ink spread with no sheet pre-drying or pre-heating.

FIG. 4 provides a photomicrograph showing first and second side ink spread with sheet pre-drying or pre-heating.

FIG. 5 provides an illustration showing a system implementing the present solution.

FIG. 6 provides an illustration that is useful for understanding a Simplex printing scenario.

FIG. 7 provides an illustration that is useful for understanding a Duplex printing scenario.

FIG. 8 provides an illustration showing a difference between the Sneeze and Flush-line jet health options of a printer.

FIGS. 9A-9B (collectively referred to as “FIG. 9”) provides a flow diagram of an illustrative method for operating a system in accordance with the present solution.

FIG. 10 provides a graph showing line quality as a function of virtual drop size on a worst performing matte coated stocks of paper.

FIG. 11 provides a graph showing line quality as a function of density on the four worst performing matte coated stocks of paper.

FIG. 12 provides a graph showing improvement of line quality by reducing the virtual drop size and applying 50% edge dithering.

FIG. 13 provides an illustration showing improvement in fine features via 50% edge dither on McCoy silk (7 pl) sheets.

FIG. 14 provides a graph showing a dash width distribution between first and second sides of a sheet of media.

FIGS. 15A-15B (collectively referred to as “FIG. 15”) provides a flow diagram of another illustrative method for operating a system in accordance with the present solution.

FIG. 16 provides a block diagram of an illustrative architecture for a computing device.

### DETAILED DESCRIPTION

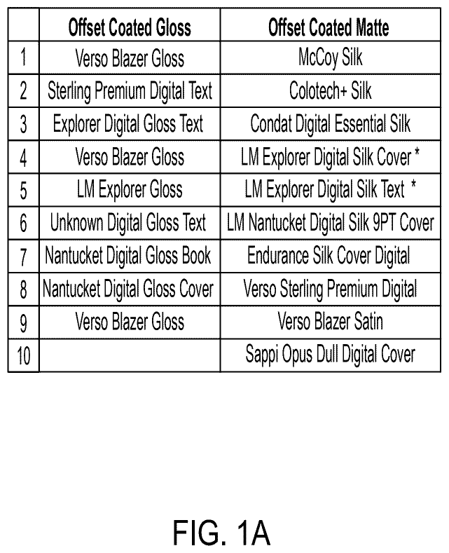

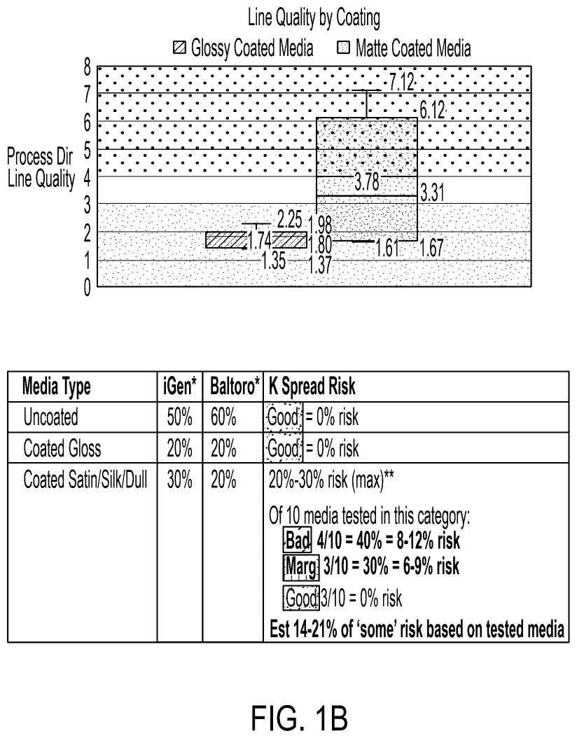

A production Aqueous Inkjet printing press must be able to produce a certain standard of image quality across a range of media's to be acceptable to the end customer. The current ink set for the production Aqueous Inkjet printing press does well at delivering a good compromise on the amount of ink spread for gloss medias and uncoated medias. However, in the matte/silk coated media category, there is a subset of those media's (3-4 in 10 roughly) which in some cases do not have the proper ink spread. The table in FIG. 1 shows that the following subset of media's performed poorly: McCoy Silk, Lindenmeyr Digital Silk Cover & Text, and Sappi Opus Digital Dull Cover. FIG. 1 also shows the resulting line quality metric for all the gloss and matte, silk coated medias listed in the table. A line quality score of less than three is ideal and having a value higher than three is not ideal. A score higher than four is considered failing.

What has been found, with this subset of the “Matte/Silk” coated medias, is that if the sheet was printed in “Simplex only” mode, then the ink spread on a first side is excessive, leading to poor fine feature performance. But if these same medias were printed in Duplex the result is that the spread on the first side is excessive, and the spread on the second side is as desired. Consequently, in the Duplex printing mode for this subset of Matte/Silk coated medias the dramatic difference in spread between the first side and the second side of the same print is a strong customer dissatisfier not only because one side has too much spread, but also because both sides of the same sheet are not consistent in image quality. Also, since the ink-set for production inkjet printers (PIJs) is locked-down (with a very long time in development to get to where it is currently at), there is a desire to create a solution to this issue that does not include changing the ink.

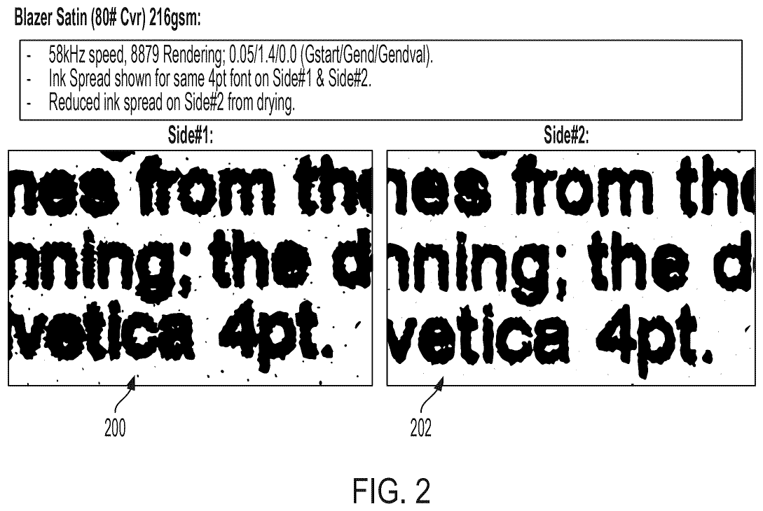

FIG. 2 shows a photomicrograph of 4 pt text printed in first and second sides 200, 202 of a sheet of Blazer Satin paper. Blazer satin is not even one of the worst papers from the standpoint of this issue, but from this picture it is clearly seen that the text on the sheet's first side is not nearly as crisp as the text on the sheet's second side which has passed through the dryer once. The Blazer Satin paper is fundamentally changed, having gone through the dryers so that the second side's ink spread (and all the IQ metrics which go along with this) are now the desired amount.

The present solution concerns systems and methods for (i) detecting if a particular media has the target amount of ink spread and (ii) implementing a paper-specific treatment option to ensure proper ink spread. Operation (i) may be accomplished by printing first test marks (e.g., for each color) on a first side of a test sheet, scanning the first side of the test sheet using a machine vision sensor to obtain first scan data, and analyzing the first scan data to determine whether the amount of ink spread on the first side of the test sheet is within a given acceptable range. The test sheet then continues around the duplex path. Second test marks are printed on a second side of the test sheet. The second side of the test sheet is scanned by the machine vision sensor to obtain second scan data. The second scan data is analyzed to determine whether the amount of ink spread on the second side of the test sheet is within an acceptable range. If both sides of the test sheet are determined to have an acceptable amount of ink spread, then the system considered the printed test marks as being of the same digital form on both sides of the test sheet.

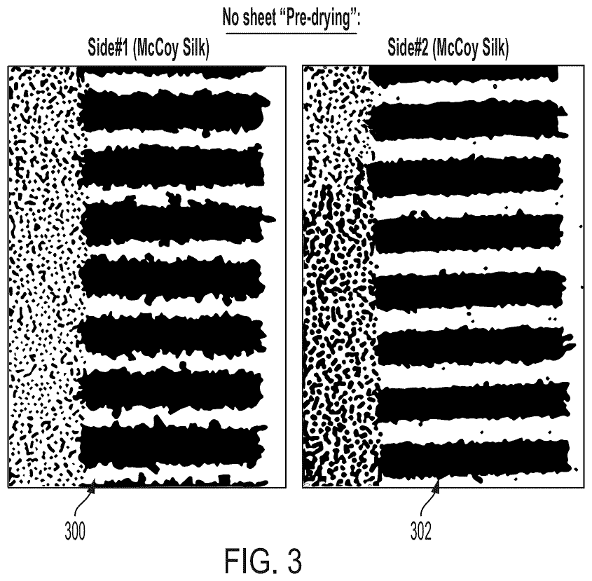

If the result of this process indicates that the ink spread is excessive on the first side and acceptable on the second side, then it demonstrates that the act of first running the sheet through the dryer is advantageous for both bringing the first side's ink spread into the acceptable range as well as equalizing the first and second side performances. FIG. 3 shows printed photomicrographs which were produced when the sheet is not pre-dried (i.e., was not run through the dryer prior to printing of the photomicrograph on the first and second sides 300, 302 of the sheet). As can be seen in FIG. 3, the ink spread is excessive on the first side 300 and acceptable on the second side 302.

In this case where the sheet pre-drying produces the desired effect, the sheet may be sent around the path a total of two or three times. If it is a Simplex print job, the sheet may be sent around the path first to dry the sheet to enable the correct amount of ink spread, and then printed on the first side of the sheet. If it is a Duplex print job, the sheet may be sent around the path first to dry the sheet to enable proper ink spreading. The sheet goes around the path the next two times for printing the first side and second side image, for a total of three times.

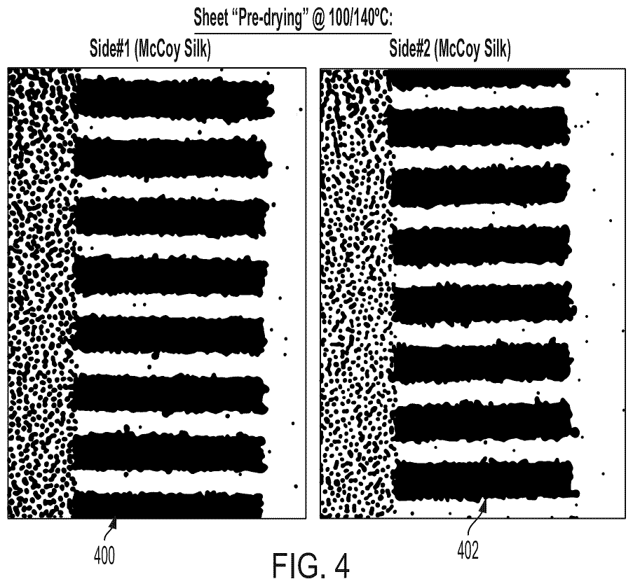

FIG. 4 shows illustrative results of the process including the step of pre-drying of the Duplex sheet of paper. The ink spread on the first and second sides 400, 402 of the sheet is in control, for example, within specification for the McCoy Silk media which was one of the worst performing medias without the treatment. This approach is effective at both printing speeds (Nominal, 40 kHz and Fast, 58 kHz) with dryer setpoints at 100° C. for a first dryer and 140° C. for a second dryer.

Typically, when a sheet is being printed, a certain amount of background jetting (i.e., Sneeze) is applied to the sheet to maintain printhead jetting health. If the print job is Simplex, the Sneeze is on one side of the sheet with no other marking, and the opposite side of the sheet receives normal marking for the image, including Sneeze. In the case of a Duplex printing job, if during the sheet pre-drying step Sneeze were applied the result would be twice the nominal amount since it also receives Sneeze when the image was printed on that same side of the paper. This is undesirable from an IQ standpoint (too much Sneeze is visible on the sheet by the end customer). Different approaches could be used to maintain jetting health while not degrading Image Quality.

The different approaches can include, but are not limited to, to the following approaches. A first approach to solving this issue is to run the Flush Line option instead of the Sneeze option. The Flush Line is simply an exercising of jets on the first or second side of sheet (instead of Sneeze throughout the sheet) to keep the jets healthy. Also, the paper-path could be run a sheet burst mode, and while sheets are being pre-dried the print-bars can be temporarily raised up from the docked position. By un-docking the print bar, the influence of the entrained airflow is greatly reduced in the path which will reduce the negative effects of passing sheets without Sneeze. Alternatively, it has been found that Yellow is generally the only color that is sensitive to the dead-cycling effect of passing sheets by the print-bar with no ink throughput. Yellow, since it is nearly invisible to the eye could be always sneezed when the paper passes under the marker (even the pre-drying pass).

The above described process has many advantages for the subset of Matte/Silk coated medias with inherent excessive ink spread. The benefits and/or advantages include, but are not limited to: improved ink spread stability: delivery of a target first side ink spread (and related IQ metrics); a delivery of equivalent first and second side ink spread to enable ability to meet IQ targets; no additional hardware requirements to the existing PIJ press, only minor software modifications to sheet scheduling; and an ability to address printhead jet-health by several different means (in both Simplex and Duplex printing).

The present solution may additionally or alternatively involve detecting variability in ink spread between the simplex and duplex printed side of any media. This detection may be accomplished by printing a target consisting of several process direction lines and using the machine vision sensor to capture the widths and peak intensity of these lines. If the difference between the line widths and/or peak intensities of the first and second sides exceeds a certain threshold (established based on visual objectionability), the system may perform a normalization routine to reduce this variability. The normalization routine involves making decrements in the virtual drop size with and without edge dithering to contain ink spread on either side of the media till convergence that pushes the difference of dash widths to fall below visually detectable levels. The virtual drop size settings and edge dither settings for each side of the media is then used for actual printing tasks.

The virtual drop size refers to a size of drops of colored ink ejected from a printhead. The volume of an ink drop may be measured in picoliters (pl). The virtual drop size may include, but is not limited to, a drop size of 1 pl, a drop size of 2 pl, a drop size of 3 pl, a drop size of 4 pl, a drop size of 5 pl, a drop size of 6 pl, and one or more drop sizes between 1 pl and 6 pl. Edge dithering is a technique where dots are printed in pre-defined dither pattern(s) in order to create definite color boundaries, smooth color gradations, and/or smooth curves.

This process has many benefits and advantages for the subset of offset coated matte medias with inherent excessive ink spread. The benefits and/or advantages include, but are not limited to: improved ink spread stability; a delivery of a target first side ink spread (and related IQ metrics); a delivery of an equivalent ink spread on the first and second sides of the sheet to enable ability to meet IQ targets; and no additional hardware requirements to the existing PIJ press.

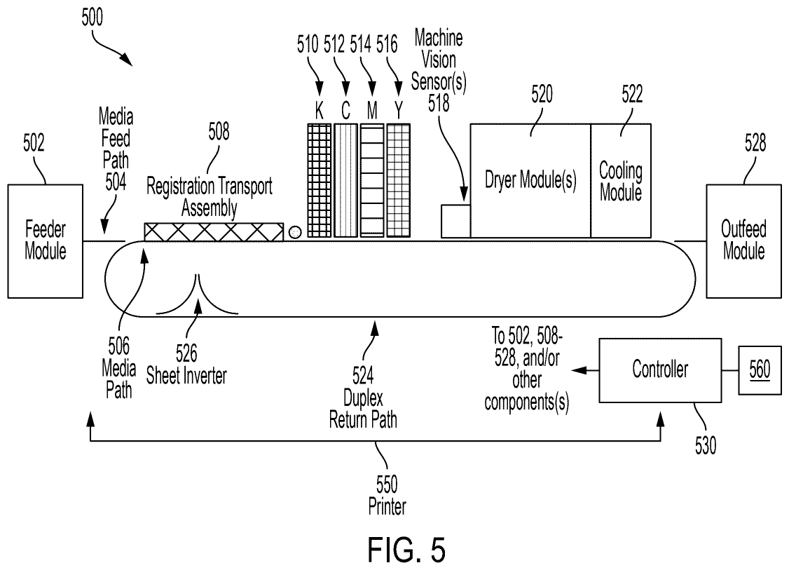

FIG. 5 provides an illustration of a system 500. System 500 can include, but is not limited to, a PIJ press, and/or a multifunction printer, scanner or copier. System 500 comprises a printer 550 that is generally configured to print text, graphics and/or images on sheets of inkjet treated sheets or non-Inkjet treated sheets with or without coating(s). The inkjet treated sheets or non-Inkjet treated sheets can include, but are not limited to, sheets of paper with no coating, sheets of paper with a glossy coating, sheets of paper with a matte coating, and/or sheets of paper with a silk coating.

System 500 comprises a feeder module 502 configured to automatically pick up sheet(s) of media and feed the same into the printer 550 one sheet at a time via a media feed path 504. Any known or to be known feeder module can be used here.

Printer 550 comprises a registration transport assembly 508, printheads 510-516, machine vision sensor(s) 518, dryer module(s) 520, and a cooling module 522. Each of the listed components 508-522 is known. The machine vision sensor(s) 518 can include, but is(are) not limited to, camera(s), laser sensor(s), thermal imaging sensor(s), and/or other vision sensor(s).

The registration transport assembly 508 is generally configured to properly align the sheet of media and place it in the media path 506 so that any impression on the sheet occurs in the precise position as intended. The impression can include, but is not limited to, ink marking(s). The sheet continues on the media path 506 towards the printheads 510-516. Printheads 510-516 are generally configured to transfer color onto sheet(s) of media. For example, printhead 510 is configured to apply ink of a key color on sheet(s). The key color can include, but is not limited to, black. Printhead 512 is configured to apply cyan ink on sheet(s). Printhead 514 is configured to apply magenta ink on sheet(s). Printhead 516 is configured to apply yellow ink on sheet(s). The applied ink may be dried by dryer module(s) 520. A cooling module 522 is provided to cool the sheet of media after passing through the dryer module(s) 520 and cause the sheet of media to either (i) return to the beginning of the process via a duplex return path 524 or (ii) continue to an outfeed module 528 where it is put in a tray for retrieval by a user.

A controller 530 is provided for controlling operations of components 502, 508-522, 526, 528 of system 500. Controller can include, but is not limited to, a processor, a computing device, and/or an electronic circuit. Controller 530 implements the present solution for improving printing results of the above described operations of the printer 550. In this regard, controller 530 is configured to (i) detect if a particular media has the target amount of ink spread and (ii) implement a paper-specific treatment option to ensure proper ink spread. Operation (i) may be accomplished by: feeding a test sheet of media into the printer 550; controlling the printer 550 to print first test marks (e.g., one or more for each color) on a first side of the test sheet; control operations of machine vision sensor(s) 518 to scan the first side of the test sheet to obtain first scan data; receive the first scan data from the machine vision sensor(s) 518; analyze or otherwise process the first scan data to determine whether an amount of ink spread on the first side of the test sheet is within a given acceptable range; control the printer 550 to cause the sheet to travel along the duplex return path 524; control the printheads 510-516 to apply test marks on a second side of the test sheet; control the operations of machine vision sensor(s) 518 to scan the second side of the test sheet to obtain second scan data; receive the second scan data from the machine vision sensor(s) 518; and/or analyze or otherwise process the second scan data to determine whether the amount of ink spread on the second side of the test sheet is within the given acceptable range. The above listed operations can be performed in a different order.

If both sides of the test sheet are determined to have an acceptable amount of ink spread, then the controller 530 considers the applied test marks as being of the same digital form on both sides of the test sheet. As such, print jobs can be scheduled with any adjustments to the printer's operations. However, if the result of the scan data analysis indicates that the ink spread is excessive on one or both sides, then the controller 530 concludes that operation of the printer 550 should be changed, altered, modified, adjusted and/or reconfigured prior to performance of any print jobs. The operations of the printer 550 may be changed, altered, modified, adjusted and/or reconfigured to bring the ink spread of both sides within the given acceptable range and/or equalize the first and second side performances. The operation of the printer 550 may be changed, altered, modified, adjusted and/or reconfigured by, for example, causing a pre-drying cycle to be performed prior to any ink application on a sheet of media.

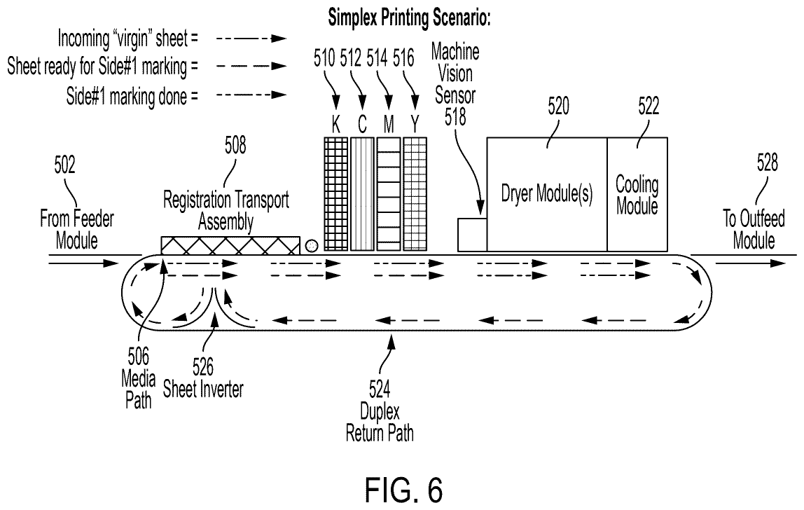

FIG. 6 shows the case in which a print job is a Simplex print job. As shown in FIG. 6, the sheet of media is sent around paths 506, 524 multiple times. During the first time that the sheet travels along media path 506, the printheads 510-512 do not apply ink thereto. The dryer module(s) 520 apply(ies) heat to dry the sheet. During the second time that the sheet travels along media path 506, the printheads 510-512 apply ink to a first side of the sheet. The dryer module(s) 520 may once again apply(ies) heat to the sheet for drying the ink which was applied to the first side of the sheet.

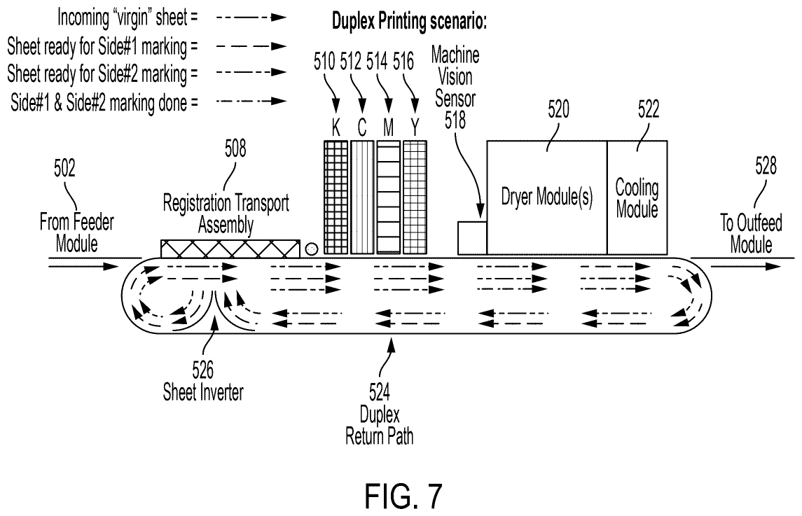

FIG. 7 shows the case in which a print job is a Duplex print job. As shown in FIG. 7, the sheet of media is sent around paths 506, 524 multiple times. During a first time that the sheet travels along media path 506, the printheads 510-512 do not apply ink thereto. The dryer module(s) 520 apply(ies) heat to dry the sheet. During the second time that the sheet travels along media path 506, the printheads 510-512 apply ink to a first side of the sheet. The dryer module(s) 520 may once again apply(ies) heat to the sheet for drying the ink which was applied to the first side of the sheet. During a third time that the sheet travels along media path 506, the printheads apply ink to a second side of the sheet. The dryer module(s) 520 may once again apply(ies) heat to the sheet for drying the ink which was applied to the second side of the sheet.

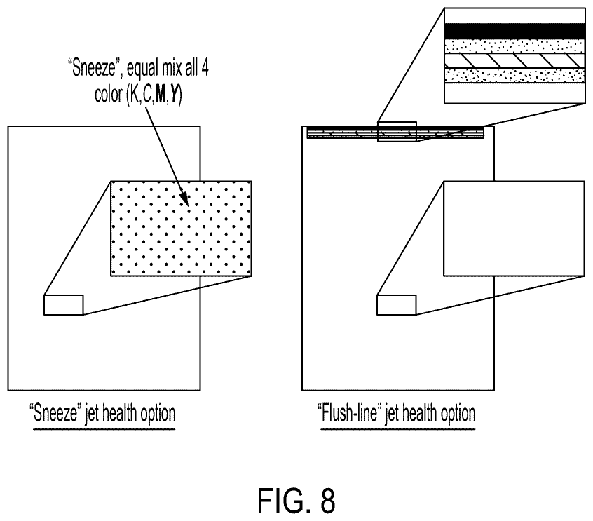

When ink is being applied to a sheet, background jetting (i.e., Sneeze) is applied to the sheet to maintain printhead jetting health. If the print job is a Simplex print job, the Sneeze is on one side of the sheet with no other marking, and the opposite side of the sheet receives normal marking for the image, including Sneeze. In the case of a Duplex print job, if during the sheet pre-drying step Sneeze were applied, then the result would be twice the nominal amount since it also receives Sneeze when the image is printed on that same side of the paper. This is undesirable from an image quality standpoint (too much Sneeze is visible on the sheet by the end customer). Different approaches may be selected by the controller 530 to maintain jetting health while not degrading image quality. For example, the controller 530 may control the printer 550 to: operate in a flush-line mode in which each printhead is exercised to clear its nozzle by printing a line on the first or second side of sheet; run in a sheet burst mode while print bars are temporarily raised up from their docked positions; or operate in a Sneeze mode in which only yellow ink is sneezed from the printhead 516 when the sheet of media passes thereunder (even during the pre-drying pass). An illustration is provided in FIG. 8 showing the difference between a sneeze jet health option and a flush-line jet health option.

For specific medias, the controller 530 may normalize settings for the same. In this regard, the controller 530 may be configured to additionally or alternatively detect a variability in ink spread between the Simplex and Duplex printed side of any media. This detection may be accomplished by printing a target consisting of several process direction lines and using the machine vision sensor(s) 518 to capture the widths and peak intensity of these lines. The controller 530 may perform the following operations: determine a first difference between the average line width of the first side and the average line width of the second side; determine a second difference between a peak intensity of the first side and a peak intensity of the second side; compare the first difference to a first threshold; compare the second difference to a second threshold; and performing a normalization routine based on results of the comparison operation(s). The normalization routine is performed to reduce the variability in the line widths and/or peak intensities. The normalization routine involves making decrements in the virtual drop size with and without edge dithering to contain ink spread on either side of the media till convergence that pushes the difference of dash widths to fall below visually detectable levels. The virtual drop size settings and edge dither settings for each side of the media is then used for actual printing tasks.

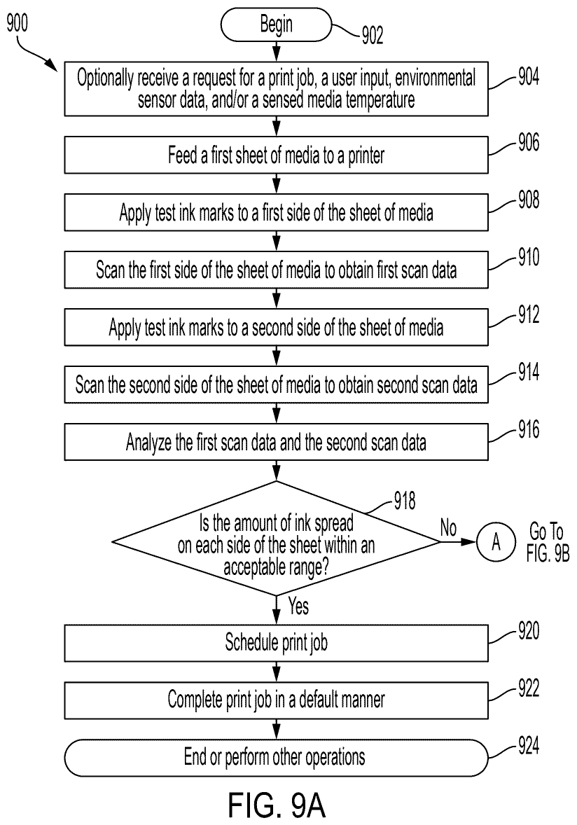

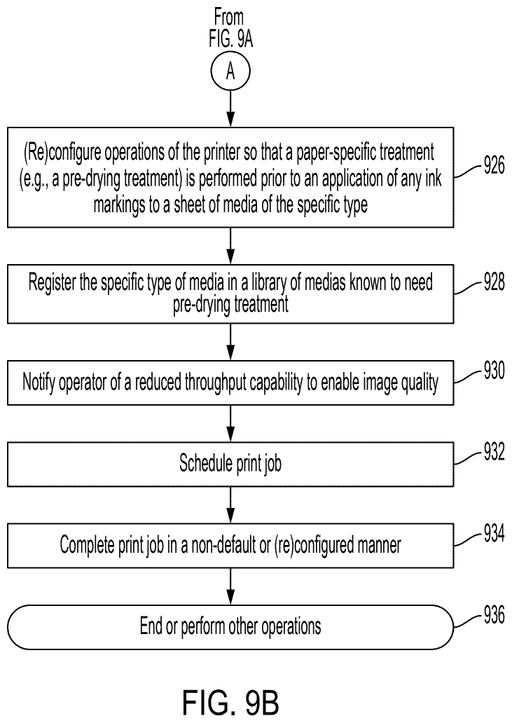

FIG. 9 provides a flow diagram of an illustrative method 900 for operating a system (e.g., system 500 of FIG. 5). The operations of blocks 900-934 of FIG. 9 may be performed in the same or different order than the order shown.

Method 900 begins with 902 and continues to optional block 904 in which a request for a print job is received by a controller (e.g., controller 530 of FIG. 5) of the system, a user input is received by the controller, environmental sensor data is received from an environmental sensor (e.g., sensor 560 of FIG. 5) by the controller, and/or a sensed media temperature is received by the controller for example from a temperature sensor (e.g., sensor 560 of FIG. 5) of the system. The environmental sensor can include, but is not limited to, a humidity sensor. In some scenarios, further operations of method 900 may be trigger, initiated and/or otherwise started based on the information received by the controller in block 904. For example, further operations of method 900 are triggered when (i) a print job request has been received, (ii) a user input has been received to begin a printing test for a new type of media, quality control and/or troubleshoot a printing issue, (iii) the humidity of the surrounding environment is above a pre-specified humidity threshold value, and/or (iv) the sensor or otherwise measured temperature of the media is below a pre-defined temperature threshold value. The present solution is not limited in this regard.

In block 906, a first sheet of media is fed into a printer (e.g., printer 550 of FIG. 5). Any known or to be known technique for feeding a sheet of media to a printer can be used here. At the printer, test ink marks are applied in block 908 to a first side of the sheet of media. The test ink marks can include marks for each ink color and/or marks of any shape and/or size. Any known or to be known technique for applying ink marks to media can be used here. The first side of sheet is scanned in block 910 to obtain first scan data. This scanning can be achieved using machine vision sensor(s) (e.g., sensor(s) 518 of FIG. 5) of the printer.

Test ink marks are applied in block 912 to a second side of the sheet of media. The test marks may be the same as or different than the test marks applied to the first side of the sheet. Any known or to be known technique for apply ink marks to media can be used here. The second side of sheet is scanned in block 914 to obtain second scan data. This scanning can be achieved using machine vision sensor(s) (e.g., sensor(s) 518 of FIG. 5) of the printer.

The first and second scan data is analyzed by the controller in block 916. The analysis is performed to determine if an amount of ink spread on each side of the sheet is within an acceptable range. If so [918:YES], then method 900 continues to 920 where the print job is scheduled. The print job is completed by the printer in a known default manner, as shown by block 922. Default settings for print jobs are well known, and may be used here. Subsequently, method 900 continues to block 924 where it ends or other operations are performed (e.g., return to block 904).

If not [918:YES], then method 900 continues to block 926 of FIG. 9B. As shown in FIG. 9B, block 926 involves performing operations by the controller to (re)configure the printer so that a paper-specific treatment (e.g., a pre-drying treatment) is performed prior to an application of any ink markings to a sheet of media of the specific type during subsequent scheduled print jobs. The controller also performs operations in block 928 to register the specific type of media in a library of media known to need pre-drying treatment, and/or block 930 to notify an operator of a reduced throughput capability to enable image quality. The notification can be output visually, auditorily and/or tactically from the controller or another device of the system in accordance with any known or to be known manner.

Next in block 932, the print job is scheduled by the controller. The print job is completed by the printer in the non-default or (re)configured manner, as shown by block 934. The non-default or (re)configured manner can include, but is not limited to, performance of a pre-drying treatment, operating the printer in a flush-line mode in which each printhead is exercised to clear its nozzle by printing a line on the first or second side of sheet, running the printer in a sheet burst mode while print bars are temporarily raised up from their docked positions, or operate the printer in a Sneeze mode in which only yellow ink is sneezed from the printhead when the sheet of media passes thereunder (even during a pre-drying pass). Subsequently, method 900 continues to block 936 where it ends or other operations are performed (e.g., return to block 904).

The non-default or (re)configured manner for completing a Simplex print job can involve sending a sheet of media through a media paths (e.g., path 506 of FIG. 5) multiple times. During the first time that the sheet travels along media path, printheads (e.g., printheads 510-512 of FIG. 5) do not apply ink thereto. Dryer module(s) (e.g., module(s) 520 of FIG. 5) apply(ies) heat to pre-dry the sheet. During the second time that the sheet travels along the media path, the printheads apply ink markings to a first side of the sheet. The dryer module(s) may once again apply(ies) heat to the sheet for drying the ink markings which were applied to the first side of the sheet. The sheet of media may then be output from the printer.

The non-default or (re)configured manner for completing a Duplex print job can involve sending a sheet of media through a media path (e.g., path 506 of FIG. 5) multiple times. During a first time that the sheet travels along media path, the printheads do not apply ink thereto. The dryer module(s) apply(ies) heat to dry the sheet. During the second time that the sheet travels along media path, the printheads apply ink markings to a first side of the sheet. The dryer module(s) may once again apply(ies) heat to the sheet for drying the ink markings which were applied to the first side of the sheet. During a third time that the sheet travels along media path, the printheads apply ink markings to a second side of the sheet. The dryer module(s) may once again apply(ies) heat to the sheet for drying the ink markings which were applied to the second side of the sheet.

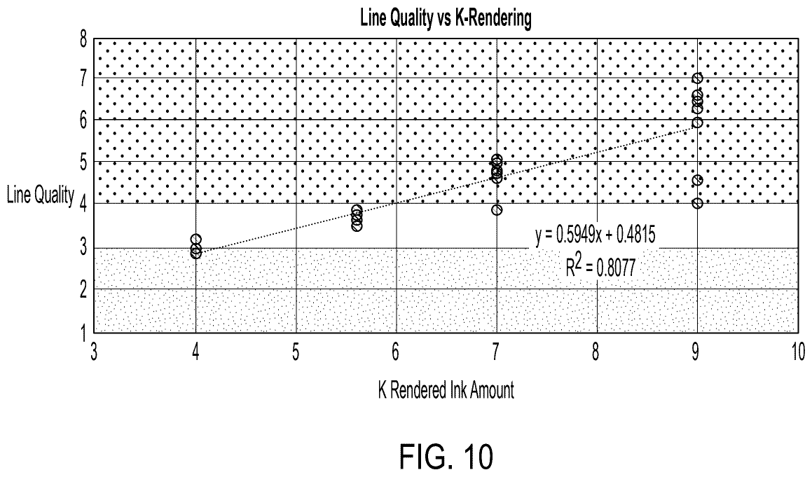

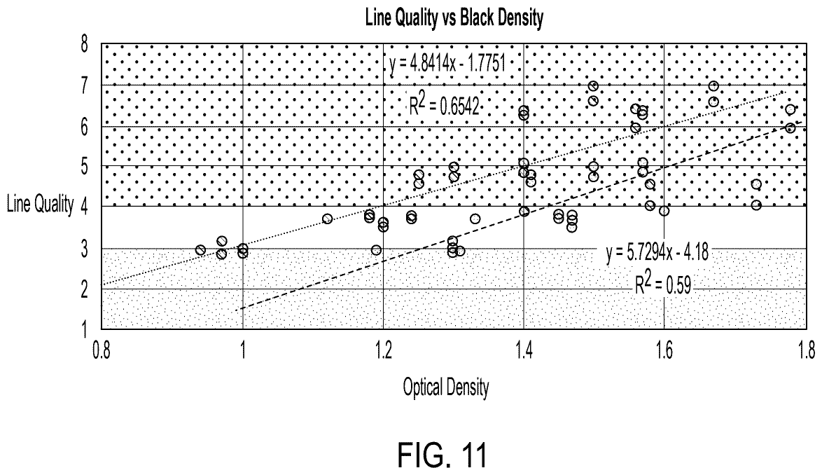

As noted above, line quality may be improved by reducing the virtual drop size. The graph 1000 of FIG. 10 demonstrates potential improvements to line quality that can be brought about by reducing the virtual drop size from 9 pl (56.25% area coverage) to 4 pl (25% area coverage). Four worst performing matte coated medias (i.e., McCoy Silk, Lindenmeyr Digital Silk Cover & Text, Sappi Opus Digital Dull Cover) were used to demonstrate improvement that would bring line quality into the domain of acceptability. As can be seen in the plot a linear relationship exists between line quality and rendered ink amount for black on the worst performing matte coated stocks. Reducing virtual drop size results in a significant improvement in line quality—but comes at a cost—K density as can be seen in FIG. 11.

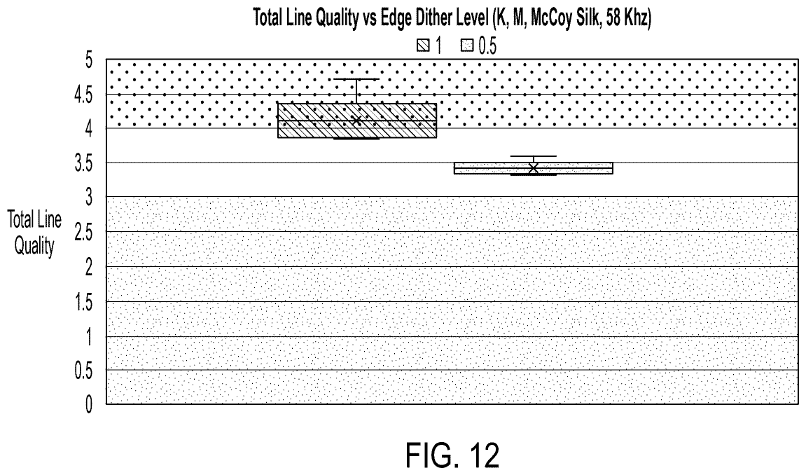

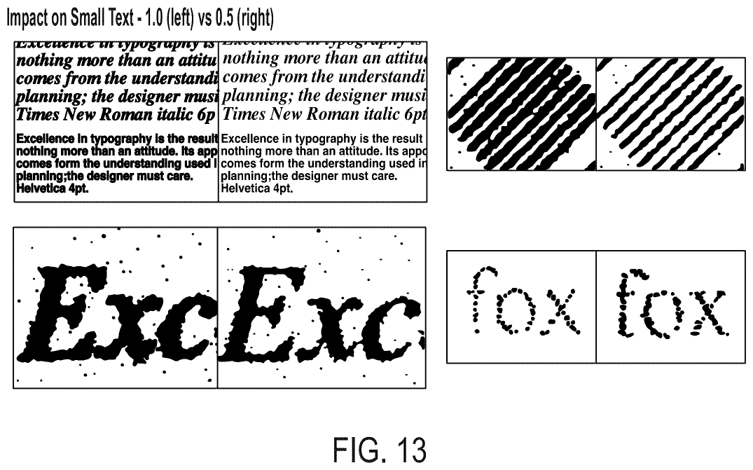

A further improvement in Line Quality can be made by dithering the edges to have an additional means of controlling the spread of the ink. FIG. 12 demonstrates the improvements brought about by dithering the edges to 50% (50% less inks at the edges as compared to elsewhere). The media used was McCoy Silk, one of the worst spreading medias and the virtual drop size used was 7 pl (43.75% area coverage). Dithering edges to 50% yields a tighter distribution around a lower median (4.1→3.4). Excluding Cyan (M, K are the inks with the highest spread) makes the improvement much more apparent. This improvement falls well outside the just noticeable difference for line quality (0.25-0.5). FIG. 13 shows the improvement in fine features via 50% edge dither on McCoy silk media (7 pl).

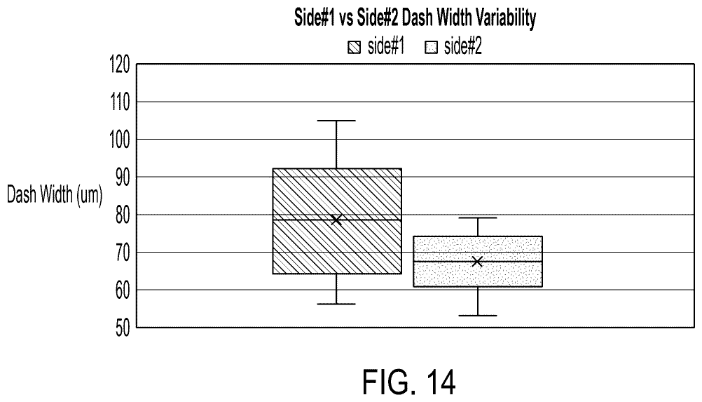

The optimal virtual drop size to improve line quality without compromising significantly on K density (OD>1.3) would fall between 6-9 pl with 50% edge dither enabled. The present solution concerns a method to detect variability in ink spread between the simplex and duplex printed side of any media. This can be accomplished by printing a target consisting of several process direction lines and using the machine vision sensor(s) to capture the widths and peak intensity of these lines. The process direction lines may be made at various virtual drop sizes ranging from 6-9 pl (37.5-56.25% area coverage) with and without 50% edge dither enabled. The increments may be 0.5 pl to limit the number of cases being processed. FIG. 14 demonstrates a hypothetical dash width distribution between first and second sides of a sheet. The first side of the sheet is expected to have a wider distribution. However, reducing virtual drop size as well as applying 50% edge dither causes rapid reduction in ink spread and causes rapid convergence with ink spread on the second side of the sheet. To maximize gamut the highest virtual drop size that causes convergence may be chosen.

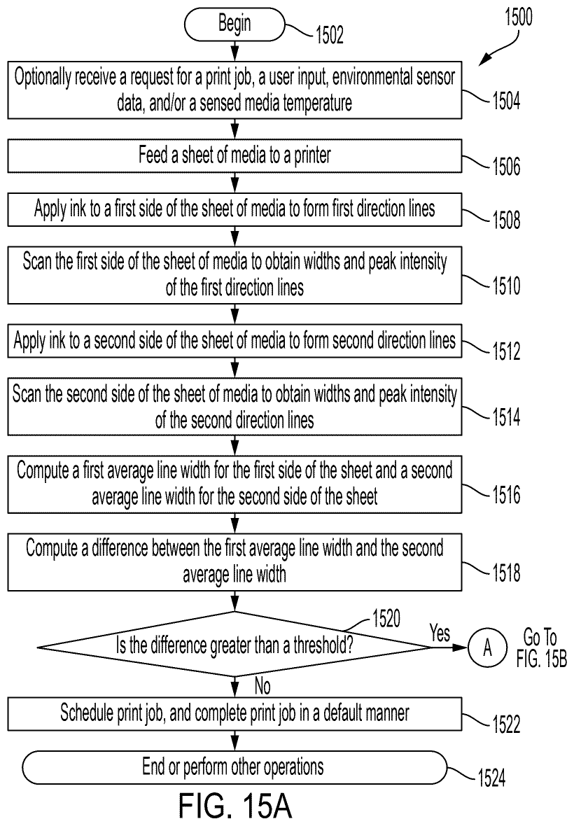

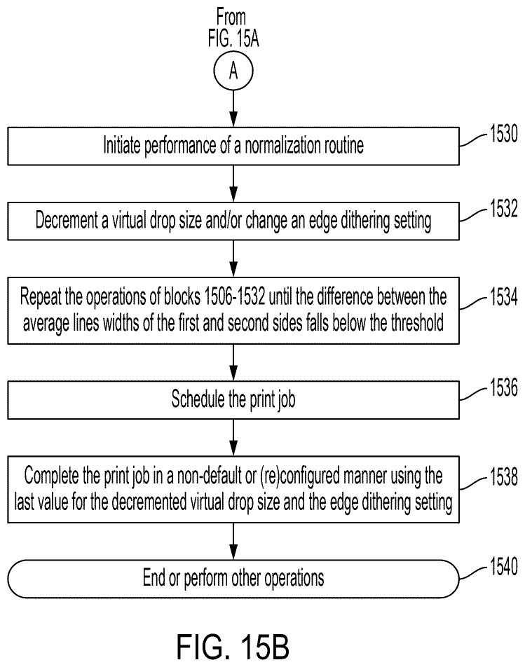

FIG. 15 provides a flow diagram of a method 1500 for improving line quality. The operations of FIG. 15 may be performed in the same or a different order than that shown. The operations of blocks 1502-1534 may be performed between blocks 930 and 932 of FIG. 9. In this case, the operations of block 1536 of FIG. 15 may be combined with the operations of block 932 of FIG. 9, and the operations of block 1538 of FIG. 15 may be combined with the operations of block 934 of FIG. 9. The present solution is not limited in this regard.

Method 1500 begins with 1502 and continues with optional block 1504 where a request for a print job is received by a controller (e.g., controller 530 of FIG. 5) of the system, a user input is received by the controller, environmental sensor data is received from an environmental sensor (e.g., sensor 560 of FIG. 5) by the controller, and/or a sensed media temperature is received by the controller for example from a temperature sensor (e.g., sensor 560 of FIG. 5) of the system. The environmental sensor can include, but is not limited to, a humidity sensor. In some scenarios, further operations of method 1500 may be trigger, initiated and/or otherwise started based on the information received by the controller in block 1504. For example, further operations of method 1500 are triggered when (i) a print job request has been received, (ii) a user input has been received to begin a printing test for a new type of media, quality control and/or troubleshoot a printing issue, (iii) the humidity of the surrounding environment is above a pre-specified humidity threshold value, and/or (iv) the sensor or otherwise measured temperature of the media is below a pre-defined temperature threshold value. The present solution is not limited in this regard.

A sheet of media is fed by a feeder module (e.g., feeder module 502 of FIG. 5) to a printer (e.g., printer 550 of FIG. 5) in block 1506. In block 1508, ink is applied to a first side of the sheet of media. The ink is applied so as to form first direction lines. The first side of the sheet is scanned in block 1510 using machine vision sensor(s) 518. The scanning is performed to obtain a width of each first direction line and to obtain a peak intensity of the first direction lines. Ink is applied to the second side of the sheet in block 1512. The ink is applied so as to form second direction lines. The second side of the sheet is scanned in block 1514 using machine vision sensor(s) 518. The scanning is performed to obtain a width of each second direction line and to obtain a peak intensity of the second direction lines. Lines printed on the first and second sides should be sent digitally in the same exact manner (i.e., same inkjets used and the same direction relative to the process direction), so that the only difference between the first and second side lines is the interaction of the ink spread on the first side and the second side. Then knowing the outcome of this test, the printer can take the two methods of corrective action described in this document, which are a) pre-drying the sheet or b) reducing rendered drop size & edge dithering.

Next in block 1516, a controller (e.g., controller 530 of FIG. 5) performs operations to compute a first average line width for the first side of the sheet and compute a second average line width for the second side of the sheet. A difference between the first and second average line widths is computed in block 1518. The difference is compared to a threshold in block 1520. If the difference is less than or equal to the threshold [1520:NO], then method 1500 continues with the operations of blocks 1522-1524. The operations involve: scheduling the print job; and completing the print job in a default manner. Once the print job is completed, method 1500 ends or other operations are performed (e.g., return to block 1502).

If the difference is greater than the threshold [1520:YES], then method 1500 continues to block 1526 of FIG. 15B. Block 1526 involves initiating performance of a normalization routine. As shown by blocks 1532-1534, the normalization routine involves: decrementing a virtual drop size and/or changing an edge dithering setting so that edge dithering is or is not performed; and repeating the operations of blocks 1506-1532 until the difference between the average line widths of the first and second sides of the sheet falls below the threshold.

When the average line widths of the first and second sides of the sheet falls below the threshold, the print job is scheduled as shown by block 1536. The print job is completed in block 1538 in a non-default or (re)configured manner using the last value of the decremented virtual drop size and the edge dithering setting specifying whether or not edge dithering is to be performed. Subsequently, method 1500 continues to block 1540 where it ends or other operations are performed (e.g., return to block 1502 of FIG. 15A).

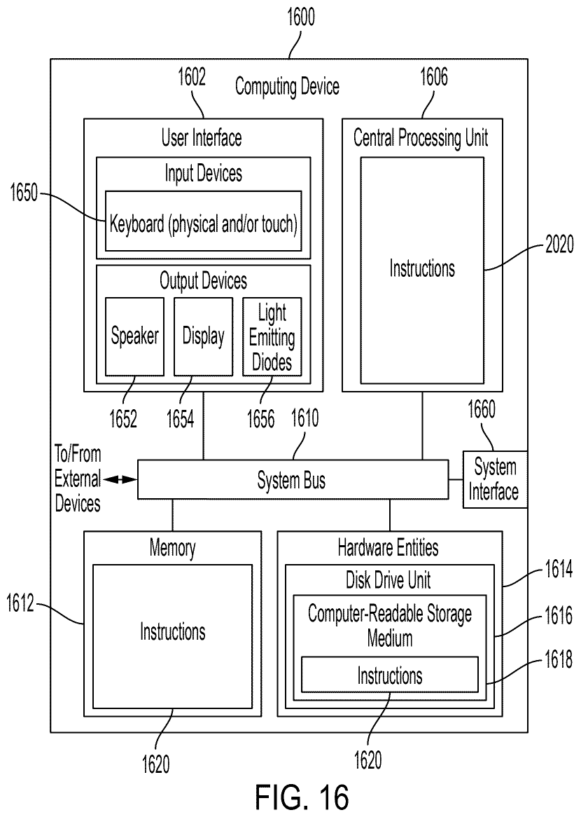

Referring now to FIG. 16, there is shown an illustrative architecture for a computing device 1600. The controller 530 of FIG. 5 is/are the same as or similar to computing device 1600. As such, the discussion of computing device 1600 is sufficient for understanding the controller 530 of FIG. 5.

Computing device 1600 may include more or less components than those shown in FIG. 16. However, the components shown are sufficient to disclose an illustrative solution implementing the present solution. The hardware architecture of FIG. 16 represents one implementation of a representative computing device configured to receive information, process the receive information, transmit information and/or control operations of an aerial vehicle, as described herein. As such, the computing device 1600 of FIG. 16 implements at least a portion of the method(s) described herein.

Some or all components of the computing device 1600 can be implemented as hardware, software and/or a combination of hardware and software. The hardware includes, but is not limited to, one or more electronic circuits. The electronic circuits can include, but are not limited to, passive components (e.g., resistors and capacitors) and/or active components (e.g., amplifiers and/or microprocessors). The passive and/or active components can be adapted to, arranged to and/or programmed to perform one or more of the methodologies, procedures, or functions described herein.

As shown in FIG. 16, the computing device 1600 comprises a user interface 1602, a Central Processing Unit (CPU) 1606, a system bus 1610, a memory 1612 connected to and accessible by other portions of computing device 1600 through system bus 1610, a system interface 1660, and hardware entities 1614 connected to system bus 1610. The user interface can include input devices and output devices, which facilitate user-software interactions for controlling operations of the computing device 1600. The input devices include, but are not limited to, a physical and/or touch keyboard 1650. The input devices can be connected to the computing device 1600 via a wired or wireless connection (e.g., a Bluetooth® connection). The output devices include, but are not limited to, a speaker 1652, a display 1654, and/or light emitting diodes 1656. System interface 1660 is configured to facilitate wired or wireless communications to and from external devices (e.g., network nodes such as access points, etc.).

At least some of the hardware entities 1614 perform actions involving access to and use of memory 1612, which can be a Random Access Memory (RAM), a disk drive, flash memory, a Compact Disc Read Only Memory (CD-ROM) and/or another hardware device that is capable of storing instructions and data. Hardware entities 1614 can include a disk drive unit 1616 comprising a computer-readable storage medium 1618 on which is stored one or more sets of instructions 1620 (e.g., software code) configured to implement one or more of the methodologies, procedures, or functions described herein. The instructions 1620 can also reside, completely or at least partially, within the memory 1612 and/or within the CPU 1606 during execution thereof by the computing device 1600. The memory 1612 and the CPU 1606 also can constitute machine-readable media. The term “machine-readable media”, as used here, refers to a single medium or multiple media (e.g., a centralized or distributed database, and/or associated caches and servers) that store the one or more sets of instructions 1620. The term “machine-readable media”, as used here, also refers to any medium that is capable of storing, encoding or carrying a set of instructions 1620 for execution by the computing device 1600 and that cause the computing device 1600 to perform any one or more of the methodologies of the present disclosure.

In view of the forgoing, the present solution concerns a system (e.g., system 500 of FIG. 5) that comprises: printheads (e.g., printheads 510-516 of FIG. 5) configured to apply ink marks to a sheet of media; sensor(s) (e.g., sensor(s) 518 of FIG. 5) configured to scan the sheet of media to obtain scan data; and a processor (e.g., controller 530 of FIG. 5) configured to analyze the scan data to (i) determine whether an amount of ink spread on at least one side of the sheet of media is within a range of values, and or (ii) determine whether a difference between a first average line width associated with a first side of the sheet of media and a second average line width associated with a second side of the sheet of media is greater than a threshold value. The system is configured to perform a print job in a manner selected based on results of the analyzing.

The print job may be performed in a default manner when (i) the amount of ink spread on the at least one side of the sheet of media falls outside the range of values and or (ii) the difference between the first and second average line widths is less than the threshold value. The print job may be performed in a non-default manner when (i) the amount of ink spread on the at least one side of the sheet falls within the range of values, and or (ii) the difference between the first and second average line widths is greater than the threshold value. The non-default manner may comprise performing a paper-specific treatment prior to an application of ink marks to another sheet of media.

The paper-specific treatment may comprise applying heat to the another sheet of media using at least one dryer module of the printing system. In this regard, the processor may be further configured to cause a pre-drying of media during performance of the print job when the results of the analyzing indicates that the amount of ink spread on a first side of the sheet of media falls outside the range of values and the amount of ink spread on a second side of the sheet of media falls within the range of values. The another sheet of media may travel along a media path of the printing system two times when the print job is a Simplex print job and three times when the print job is a Duplex print job.

Additionally or alternatively, the non-default manner comprises using a drop size associated with one of a plurality of average line width differences that has a value less than the threshold value. In this regard, the processor may be further configured to perform a normalization routine prior to performance of the print job when the difference between the first and second average line widths is greater than the threshold value. The normalization routine comprises decrementing a drop size until a difference between an average line width associated with a first side of another sheet of media and an average line width associated with a second side of another sheet of media falls below the threshold value. Edge dithering may or may not be performed during the normalization routine.

The present solution also concerns a system (e.g., system 500 of FIG. 5) comprising: a processor (e.g., controller 530 of FIG. 5 and/or CPU 1606 of FIG. 16); and a non-transitory computer-readable medium (e.g., memory 1612 of FIG. 16) comprising one or more programming instructions (e.g., instructions 1620 of FIG. 16) that when executed by the processor, cause the processor to: control printheads (e.g., print heads 510-516 of FIG. 5) to apply ink marks to a sheet of media; control sensor(s) (e.g., sensor(s) 518 of FIG. 5) to generate scan data by scanning the sheet of media; analyze the scan data to (i) determine whether an amount of ink spread on at least one side of the sheet of media is within a range of values, and or (ii) determine whether a difference between a first average line width associated with a first side of the sheet of media and a second average line width associated with a second side of the sheet of media is greater than a threshold value; and control a printer (e.g., printer 550 of FIG. 5) to perform a print job in a manner selected based on results from analyzing the scan data.

The present solution further concerns implementing systems and methods for operating a printing system (e.g., system 500 of FIG. 5). The methods comprising: applying, by printheads (e.g., print heads 510-516 of FIG. 5) of the printing system, ink marks to a sheet of media; scanning, by sensor(s) (e.g., sensor(s) 518 of FIG. 5) of the printing system, the sheet of media to obtain scan data; and analyzing, by processor(s) (e.g., controller 530 of FIG. 5 and/or CPU 1606 of FIG. 16) of the printing system, the scan data to (i) determine whether an amount of ink spread on at least one side of the sheet of media is within a range of values, and or (ii) determine whether a difference between a first average line width associated with a first side of the sheet of media and a second average line width associated with a second side of the sheet of media is greater than a threshold value; and performing a print job by the printing system in a manner selected based on results of the analyzing.

The print job may be performed in a default manner when (i) the amount of ink spread on the at least one side of the sheet of media falls outside the range of values and or (ii) the difference between the first and second average line widths is less than the threshold value. The print job may be performed in a non-default manner when (iii) the amount of ink spread on the at least one side of the sheet falls within the range of values, and or (iv) the difference between the first and second average line widths is greater than the threshold value.

The non-default manner may comprise performing a paper-specific treatment prior to an application of ink marks to another sheet of media. The paper-specific treatment may comprises applying heat to the another sheet of media using at least one dryer module of the printing system. The another sheet of media may travel along a media path of the printing system two times when the print job is a Simplex print job and three times when the print job is a Duplex print job.

The non-default manner may additionally or alternatively comprise using a drop size associated with one of a plurality of average line width differences that has a value less than the threshold value. In this regard, a normalization routine may be performed prior to performing the print job when the difference between the first and second average line widths is greater than the threshold value, wherein the normalization routine comprises decrementing a drop size until a difference between an average line width associated with a first side of another sheet of media and an average line width associated with a second side of another sheet of media falls below the threshold value.

As used in this document, the singular form “a”, “an”, and “the” include plural references unless the context clearly dictates otherwise. Unless defined otherwise, all technical and scientific terms used herein have the same meanings as commonly understood by one of ordinary skill in the art. As used in this document, the term “comprising” means “including, but not limited to”.

The described features, advantages and characteristics disclosed herein may be combined in any suitable manner. One skilled in the relevant art will recognize, in light of the description herein, that the disclosed systems and/or methods can be practiced without one or more of the specific features. In other instances, additional features and advantages may be recognized in certain scenarios that may not be present in all instances.

Although the systems and methods have been illustrated and described with respect to one or more implementations, equivalent alterations and modifications will occur to others skilled in the art upon the reading and understanding of this specification and the annexed drawings. In addition, while a particular feature may have been disclosed with respect to only one of several implementations, such feature may be combined with one or more other features of the other implementations as may be desired and advantageous for any given or particular application. Thus, the breadth and scope of the disclosure herein should not be limited by any of the above descriptions. Rather, the scope of the invention should be defined in accordance with the following claims and their equivalents.

What is claimed is:

1. A system, comprising:
printheads configured to apply ink marks to a sheet of media;
a sensor configured to scan the sheet of media to obtain scan data; and
a processor configured to analyze the scan data to (i) determine whether an amount of ink spread on at least one side of the sheet of media is within a range of values, and or (ii) determine whether a difference between a first average line width associated with a first side of the sheet of media and a second average line width associated with a second side of the sheet of media is greater than a threshold value;
wherein the system is configured to perform a print job in a manner selected based on results of the analyzing.

2. The system according to claim 1, wherein the print job is performed in a default manner when (i) the amount of ink spread on the at least one side of the sheet of media falls outside the range of values and or (ii) the difference between the first and second average line widths is less than the threshold value.

3. The system according to claim 1, wherein the print job is performed in a non-default manner when (i) the amount of ink spread on the at least one side of the sheet falls within the range of values, and or (ii) the difference between the first and second average line widths is greater than the threshold value.

4. The system according to claim 3, wherein the non-default manner comprises performing a paper-specific treatment prior to an application of ink marks to another sheet of media.

5. The system according to claim 4, wherein the paper-specific treatment comprises applying heat to the another sheet of media using at least one dryer module of the printing system.

6. The system according to claim 5, wherein the another sheet of media travels along a media path of the printing system two times when the print job is a Simplex print job and three times when the print job is a Duplex print job.

7. The system according to claim 3, wherein the non-default manner comprises using a drop size associated with one of a plurality of average line width differences that has a value less than the threshold value.

8. The system according to claim 1, wherein the processor is further configured to cause a pre-drying of media during performance of the print job when the results of the analyzing indicates that the amount of ink spread on a first side of the sheet of media falls outside the range of values and the amount of ink spread on a second side of the sheet of media falls within the range of values.

9. The system according to claim 1, wherein the processor is further configured to perform a normalization routine prior to performance of the print job when the difference between the first and second average line widths is greater than the threshold value.

10. The system according to claim 9, wherein the normalization routine comprises decrementing a drop size until a difference between an average line width associated with a first side of another sheet of media and an average line width associated with a second side of another sheet of media falls below the threshold value.

11. The system according to claim 10, wherein edge dithering is performed during the normalization routine.

12. A system, comprising:
a processor; and
a non-transitory computer-readable medium comprising one or more programming instructions that when executed by the processor, cause the processor to:
control printheads to apply ink marks to a sheet of media;
control a sensor to generate scan data by scanning the sheet of media;
analyze the scan data to (i) determine whether an amount of ink spread on at least one side of the sheet of media is within a range of values, and or (ii) determine whether a difference between a first average line width associated with a first side of the sheet of media and a second average line width associated with a second side of the sheet of media is greater than a threshold value; and
control a printer to perform a print job in a manner selected based on results from analyzing the scan data.

13. A method for operating a printing system, comprising:
applying, by printheads of the printing system, ink marks to a sheet of media;
scanning, by a sensor of the printing system, the sheet of media to obtain scan data;
analyzing, by a processor of the printing system, the scan data to (i) determine whether an amount of ink spread on at least one side of the sheet of media is within a range of values, and or (ii) determine whether a difference between a first average line width associated with a first side of the sheet of media and a second average line width associated with a second side of the sheet of media is greater than a threshold value; and
performing a print job by the printing system in a manner selected based on results of the analyzing.

14. The method according to claim 13, wherein the print job is performed in a default manner when (i) the amount of ink spread on the at least one side of the sheet of media falls outside the range of values and or (ii) the difference between the first and second average line widths is less than the threshold value.

15. The method according to claim 13, wherein the print job is performed in a non-default manner when (iii) the amount of ink spread on the at least one side of the sheet falls within the range of values, and or (iv) the difference between the first and second average line widths is greater than the threshold value.

16. The method according to claim 15, wherein the non-default manner comprises performing a paper-specific treatment prior to an application of ink marks to another sheet of media.

17. The method according to claim 16, wherein the paper-specific treatment comprises applying heat to the another sheet of media using at least one dryer module of the printing system.

18. The method according to claim 17, wherein the another sheet of media travels along a media path of the printing system two times when the print job is a Simplex print job and three times when the print job is a Duplex print job.

19. The method according to claim 15, wherein the non-default manner comprises using a drop size associated with one of a plurality of average line width differences that has a value less than the threshold value.

20. The method according to claim 13, further comprising performing a normalization routine prior to performing the print job when the difference between the first and second average line widths is greater than the threshold value, wherein the normalization routine comprises decrementing a drop size until a difference between an average line width associated with a first side of another sheet of media and an average line width associated with a second side of another sheet of media falls below the threshold value.
